(19) United States
(12) Patent Application Publication
(10) Pub. No.: US 2025/0065500 A1
(43) Pub. Date: Feb. 27, 2025

(54) CONTROL DEVICE, ROBOT SYSTEM, CONTROL METHOD, AND RECORDING MEDIUM

(71) Applicant: NEC Corporation, Minato-ku, Tokyo (JP)

(72) Inventor: Masumi Ichien, Tokyo (JP)

(73) Assignee: NEC Corporation, Minato-ku, Tokyo (JP)

(21) Appl. No.: 18/720,759

(22) PCT Filed: Dec. 28, 2021
(86) PCT No.: PCT/JP2021/048871

§ 371 Date: Jun. 17, 2024

(51) Int. Cl. B25J 9/16

(52) U.S. Cl. CPC B25J 9/1653; B25J 9/1674; B25J 9/1697

(57) ABSTRACT

A control device generates a state sequence including a plurality of states from a state at a movement source to a state at a movement destination of a physical object. The control device determines the occurrence of an error in an operation of a robot based on a result of comparing the state of the generated state sequence with a state of the physical object during the operation of the robot operating according to the state sequence. The control device changes the state sequence so that a recovery operation for recovering from the error is performed in a case where it is determined that the error has occurred.

### TECHNICAL FIELD

The present disclosure relates to a control device, a robot system, a control method, and a recording medium.

### BACKGROUND ART

Robots are used in various fields such as logistics. Some robots operate autonomously. Patent Document 1 discloses technology related to a robot system that recovers from an error in a case where the error occurs as a related art.

### PRIOR ART DOCUMENTS

### Patent Document

Patent Document 1:
   Japanese Patent No. 5436460

### SUMMARY

### Technical Problem

In the technology described in Patent Document 1, it is difficult to reliably detect an operation error while a robot is operating. Therefore, one of the objectives of the present disclosure is to provide a control device or the like capable of reliably detecting an operation error of a robot in operation. Therefore, there is a need for technology capable of reliably detecting an operation error of the robot in operation.

An example of an objective of each aspect of the present disclosure is to provide a control device, a robot system, a control method, and a recording medium capable of solving the above problems.

### Solution to Problem

To achieve the above-described objective, according to an aspect of the present disclosure, there is provided a control device including: a first generation means configured to generate a state sequence including a plurality of states from a state at a movement source to a state at a movement destination of a physical object: a determination means configured to determine the occurrence of an error in an operation of a robot based on a result of comparing the state of the generated state sequence with a state of the physical object during the operation of the robot operating according to the state sequence; and a control means configured to change the state sequence so that a recovery operation for recovering from the error is performed in a case where it is determined that the error has occurred.

To achieve the above-described objective, according to another aspect of the present disclosure, there is provided a robot system including: the above-described control device; and a robot configured to operate in accordance with control of the control device.

To achieve the above-described objective, according to yet another aspect of the present disclosure, there is provided a control method including: generating a state sequence including a plurality of states from a state at a movement source to a state at a movement destination of a physical object: determining the occurrence of an error in an operation of a robot based on a result of comparing the state of the generated state sequence with a state of the physical object during the operation of the robot operating according to the state sequence; and changing the state sequence so that a recovery operation for recovering from the error is performed in a case where it is determined that the error has occurred.

To achieve the above-described objective, according to yet another aspect of the present disclosure, there is provided a recording medium storing a program for causing a computer to: generate a state sequence including a plurality of states from a state at a movement source to a state at a movement destination of a physical object; determine the occurrence of an error in an operation of a robot based on a result of comparing the state of the generated state sequence with a state of the physical object during the operation of the robot operating according to the state sequence; and change the state sequence so that a recovery operation for recovering from the error is performed in a case where it is determined that the error has occurred.

### Advantageous Effects of Invention

According to each aspect of the present disclosure, it is possible to reliably detect an operation error of a robot in operation.

### BRIEF DESCRIPTION OF DRAWINGS

FIG. 1 is a diagram showing an example of a configuration of a robot system according to an example embodiment of the present disclosure.

FIG. 2 is a diagram showing an example of an initial plan sequence generated by a generation unit according to an example embodiment of the present disclosure.

FIG. 3 is a diagram showing an example of an initial plan control signal generated by a control unit according to an example embodiment of the present disclosure.

FIG. 4 is a first diagram for describing a post-error sequence in an example embodiment of the present disclosure.

FIG. 5 is a second diagram for describing a post-error sequence in an example embodiment of the present disclosure.

FIG. 6 is a diagram showing an example of a processing flow of the robot system according to an example embodiment of the present disclosure.

FIG. 7 is a diagram showing an example of a processing flow of a control device having a minimum configuration according to the example embodiment of the present disclosure.

FIG. 8 is a diagram showing an example of a processing flow of the control device having the minimum configuration according to the example embodiment of the present disclosure.

FIG. 9 is a schematic block diagram showing a configuration of a computer according to at least one example embodiment.

### EXAMPLE EMBODIMENT

Hereinafter, example embodiments will be described in detail with reference to the drawings.

### EXAMPLE EMBODIMENT

A robot system 1 according to an example embodiment of the present disclosure is a system for moving a physical object placed at one position to another position and is a system for efficiently performing a recovery process in a case where the physical object fails to move on the way. The robot system 1 is, for example, a system introduced in a warehouse of a logistics center or the like.

### (Configuration of Robot System)

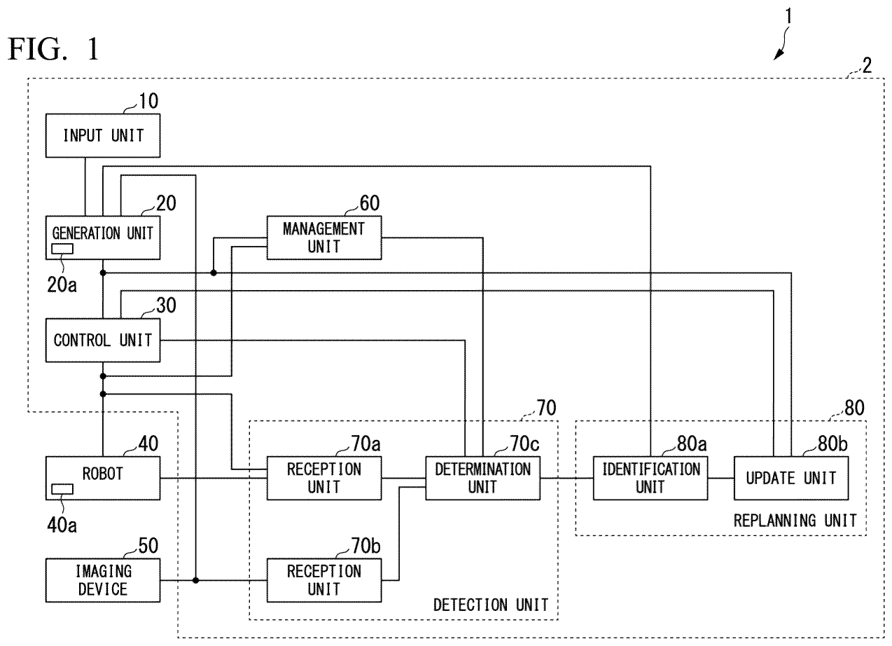

FIG. 1 is a diagram showing an example of a configuration of the robot system 1 according to an example embodiment of the present disclosure. As shown in FIG. 1, the robot system 1 includes a control device 2, a robot 40, and an imaging device 50.

The control device 2 includes an input unit 10, a generation unit 20 (an example of a first generation means and an example of a second generation means), a control unit 30 (an example of a control means), a management unit 60, a detection unit 70, and a replanning unit 80.

The input unit 10 inputs a work target and constraints to the generation unit 20. Examples of the work target include information indicating a type of physical object M, the number of physical objects M to be moved, a movement source of the physical object M, a movement destination of the physical object M, and the like. Examples of the constraints include a prohibited area in a case where the physical object M is moved, an unavailable movement area of a robot, and the like. Also, the input unit 10 may receive, for example, an input indicating that “three parts A are moved from tray A to tray B,” as the work target from an operator and identify information indicating that the type of physical object M to be moved is part A, the number of physical objects M to be moved is three, the movement source of the physical object M is tray A, and the movement destination of the physical object M is tray B and may input the identified information to the generation unit 20.

The generation unit 20 generates an initial plan sequence indicating a flow of an operation of the robot 40 based on the work target and constraints input by the input unit 10. For example, in a case where the work target and constraints are input by the input unit 10, the generation unit 20 obtains an image of the movement source of the physical object M indicated in the work target from the imaging device 50. The generation unit 20 can recognize a state (i.e., a position and posture) at the movement source of the physical object M from the image obtained from the imaging device 50. The generation unit 20 generates information indicating a state for each time step of the robot 40 on the way from a state at the movement source of the physical object M to a state at the movement destination of the physical object M (a type of physical object M, a position and posture of the robot 40, an operation currently being executed (strength of grasping of the physical object M or the like), or the like) necessary for the control unit 30 to generate a control signal for controlling the robot 40. That is, information indicating a state for each time step of the robot 40 on the way from a state at the movement source of the physical object M to a state at the movement destination of the physical object M necessary for the control unit 30 to generate a control signal for controlling the robot 40 is a sequence (an example of a state sequence). The generation unit 20 outputs the generated sequence to the control unit 30, the management unit 60, and an update unit 80b to be described below. Moreover, the generation unit 20 generates a new sequence based on a new work target generated by an identification unit 80a to be described below and outputs the generated sequence to the identification unit 80a. Also, the generation unit 20 may be implemented using artificial intelligence (AI) technology including temporal logic, reinforcement learning, optimization technology, and the like.

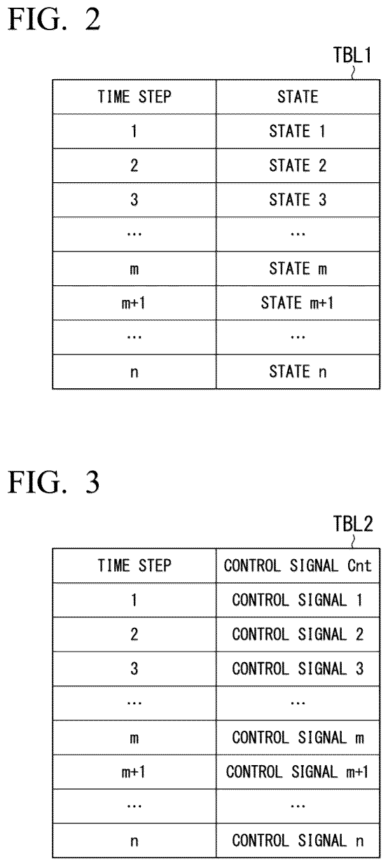

FIG. 2 is a diagram indicating an example of an initial plan sequence TBL1 generated by the generation unit 20 according to an example embodiment of the present disclosure. For example, as shown in FIG. 2, the initial plan sequence TBL1 generated by the generation unit 20 is, for example, a sequence indicating a state of the robot 40 in each of n time steps from the movement source to the movement destination of the physical object M.

The control unit 30 generates a control signal for controlling the robot 40 based on a sequence input from the outside (i.e., the generation unit 20 or the update unit 80b to be described below). Also, the control unit 30 may generate a control signal for optimizing an evaluation function in a case where the control signal is generated. Examples of the evaluation function include a function representing an amount of energy consumed by the robot 40 in a case where the physical object M is moved, a function representing a distance along a path for moving the physical object M, and the like. The control unit 30 outputs the generated control signal to the robot 40, the management unit 60, and the detection unit 70.

FIG. 3 is a diagram showing an example of an initial plan control signal Cnt generated by the control unit 30 according to an example embodiment of the present disclosure. For example, as shown in FIG. 3, the initial plan control signal Cnt generated by the control unit 30 is, for example, a control signal for each of n time steps from the movement source to the movement destination of the physical object M.

Moreover, in a case where the control unit 30 receives an error signal to be described below from the detection unit 70, the control unit 30 stops an output of the control signal to the robot 40. That is, the control unit 30 stops the control of the robot 40.

Moreover, in a case where the control unit 30 receives a resume signal and a sequence after an error from the update unit 80b to be described below in a state in which the control of the robot 40 is stopped, the control unit 30 generates a control signal for controlling the robot 40 based on the sequence.

The robot 40 grasps the physical object M in accordance with a control signal output by the control unit 30 and moves the physical object M from the movement source to the movement destination. The robot 40 includes a sensor 40a. The sensor 40a detects the state of the robot 40. Examples of the sensor 40a include a sensor configured to detect a rotational position of a motor that operates an actuator of the robot 40, a sensor configured to detect a force for grasping the physical object M (for example, a force for pinching the physical object M or a force for suctioning the physical object M), and the like. A detection result of the sensor 40a is output to the detection unit 70.

The imaging device 50 captures a state of the physical object M. The imaging device 50 is, for example, an industrial camera, and can identify a state (i.e., a position and posture) of the physical object M. The image captured by the imaging device 50 is output to the generation unit 20 and the detection unit 70.

The management unit 60 estimates current states of the robot 40 and the physical object M based on the sequence output by the generation unit 20 and the control signal output by the control unit 30. The current states of the robot 40 and the physical object M estimated by the management unit 60 are ideal states that the robot 40 and the physical object M should be in at present. The management unit 60 outputs information indicating the estimated current states of the robot 40 and the physical object M to the detection unit 70.

The detection unit 70 is a processing unit configured to detect that an error has occurred in the movement of the physical object M. As shown in FIG. 1, the detection unit 70 includes reception units 70a and 70b and a determination unit 70c (an example of a determination means).

The reception unit 70a receives a control signal output by the control unit 30. Moreover, the reception unit 70a receives a detection result of the sensor 40a (i.e., information indicating the state of the robot 40). The reception unit 70a outputs the received control signal and the received detection result to the determination unit 70c.

The reception unit 70b receives an image captured by the imaging device 50. The reception unit 70b outputs the received image to the determination unit 70c.

The determination unit 70c identifies current actual states of the robot 40 and the physical object M based on the control signal and detection result output by the reception unit 70a and the image output by the reception unit 70b. For example, in a case where the determination unit 70c determines that the grasping of the robot 40 is valid, it may be determined that the physical object M is located at a position of the tip of the robot's hand. Moreover, in a case where the grasping of the robot 40 changes from a valid state to an invalid state (in a case where the physical object M falls unexpectedly), the determination unit 70c may determine that the physical object M is located on a floor in a vertical downward direction from the tip of the robot 40 at that time. The determination unit 70c compares the identified current actual states of the robot 40 and the physical object M with the current estimated states of the robot 40 and the physical object M indicated in the information output by the management unit 60. The determination unit 70c determines whether or not an error has occurred in the movement of the physical object M based on a comparison result. In a case where it is determined that a difference between the current actual state of each of the robot 40 and the physical object M and the estimated state exceeds a predetermined threshold value, the determination unit 70c determines that an error has occurred in the movement of the physical object M. Moreover, in a case where it is determined that the difference does not exceed the predetermined threshold value, the determination unit 70c determines that no error has occurred in the movement of the physical object M. In a case where it is determined that an error has occurred in the movement of the physical object M, the determination unit 70c outputs an error signal indicating that an error has occurred to the control unit 30 and outputs the control signal, the detection result, the image (i.e., the current actual states of the robot 40 and the physical object M), and the current estimated states of the robot 40 and the physical object M to the replanning unit 80 together with the error signal.

In a case where an error occurs in the movement of the physical object M, the replanning unit 80 is a processing unit configured to generate a plan to efficiently move the physical object M to the movement destination from a state in which the error occurred. As shown in FIG. 1, the replanning unit 80 includes the identification unit 80a and the update unit 80b (an example of a third generation means).

In a case where the error signal is received, the identification unit 80a generates a new work target based on the control signal, the detection result, the image, and the current estimated states of the robot 40 and the physical object M received together with the error signal. Examples of the new work target include information for moving the physical object M from the state of the physical object M after the error in a case where the error occurred to the state of the physical object M in a case where the physical object M is grasped by the robot 40 as one of the plurality of states in the initial plan sequence, i.e., information indicating a type of physical object M, the number of physical objects M to be moved that is 1, and the state of the physical object M after the error in a case where the error occurred at the movement source of the physical object M, information indicating the state of the physical object M in a case where the physical object M is grasped by the robot 40 as one of the plurality of states in the initial plan sequence at the movement destination of the physical object M, or the like. The identification unit 80a outputs the generated new work target to the generation unit 20.

Moreover, in a case where the identification unit 80a receives a new sequence generated by the generation unit 20 for the new work target, the identification unit 80a outputs the received new sequence to the update unit 80b.

In a case where the new sequence is received from the identification unit 80a, the update unit 80b replaces states from a state at the movement source in the initial plan sequence received from the generation unit 20 to a state that is one of the plurality of states in the initial plan sequence at the movement destination of the physical object M in the new sequence with states from a state at the movement source to a state at the movement destination in the new sequence. That is, the update unit 80b moves the physical object M in the new sequence from a state of the physical object M after the error in a case where the error has occurred in the movement of the physical object M to a state that is one of the plurality of states in the initial plan sequence and then generates a post-error sequence for moving the physical object M by diverting the initial plan sequence from the one state to the state at the movement destination.

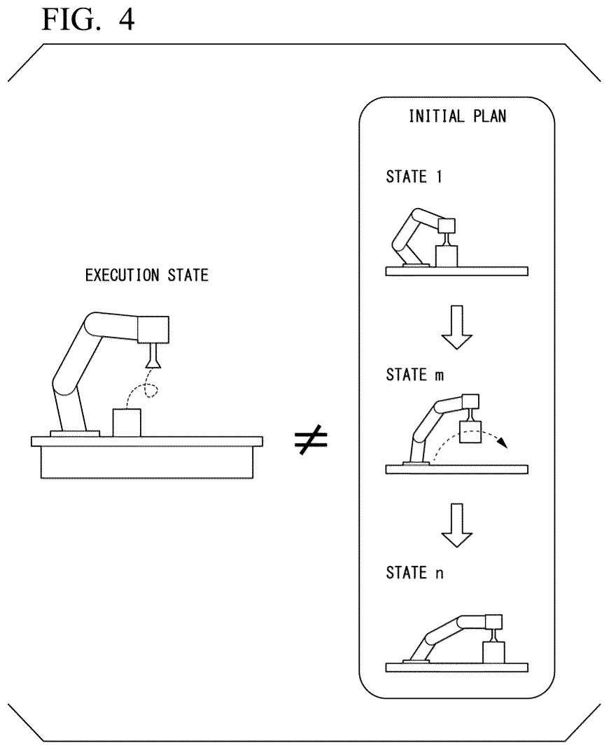

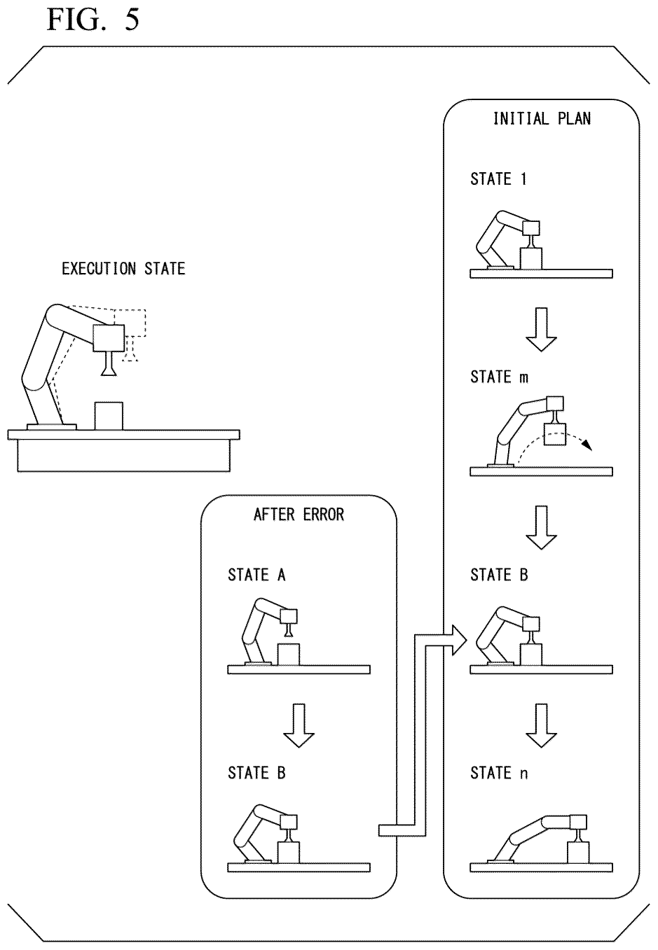

FIG. 4 is a first diagram for describing a post-error sequence in an example embodiment of the present disclosure. FIG. 5 is a second diagram for describing a post-error sequence in an example embodiment of the present disclosure. For example, it is assumed that an error has occurred in state m in the initial plan sequence from state 1 to state n shown in FIG. 4. In this case, the identification unit 80a generates a new work target and the generation unit 20 generates a sequence from state A to state B that is one of the plurality of states in the initial plan sequence with respect to the movement source of the physical object M after the error for the new work target. The update unit 80b replaces a sequence from state 1 to state B in the initial plan sequence with a new sequence (i.e., from state A to state B) generated by the generation unit 20.

For example, in a case where the initial plan sequence is the sequence TBL1 shown in FIG. 2, an error occurs in state m, and the robot 40 stops in a state of control according to a control signal m due to an error signal (i.e., in a case where state B is state m), the identification unit 80a replaces a portion of the sequence from state 1 to state m in the sequence TBL1 shown in FIG. 2 with a sequence generated by the generation unit 20 for the new work target. This replacement sequence is the post-error sequence. The identification unit 80a outputs the post-error sequence to the control unit 30 together with a resume signal indicating the resumption of control of the robot 40.

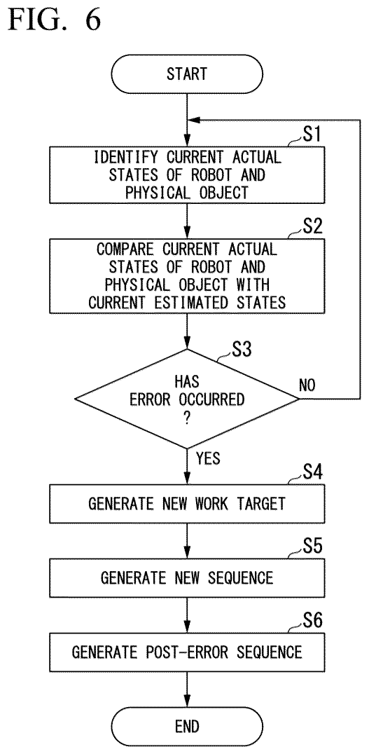

FIG. 6 is a diagram showing an example of a processing flow of the robot system 1 according to an example embodiment of the present disclosure. Next, a process performed by the robot system 1 will be described with reference to FIG. 6. It is assumed that the robot 40 is operating according to a control signal based on an initial plan sequence until an error occurs in the movement of the physical object M. Here, the process of the robot system 1 after the error occurs will be described.

The reception unit 70a receives a control signal output by the control unit 30. Moreover, the reception unit 70a receives a detection result detected by the sensor 40a (i.e., information indicating the state of the robot 40). The reception unit 70a outputs the received control signal and the received detection result to the determination unit 70c.

The reception unit 70b receives an image captured by the imaging device 50. The reception unit 70b outputs the received image to the determination unit 70c.

The determination unit 70c identifies current actual states of the robot 40 and the physical object M based on the control signal and the detection result output by the reception unit 70a and the image output by the reception unit 70b (step S1). The determination unit 70c compares the identified current actual states of the robot 40 and the physical object M with current estimated states of the robot 40 and the physical object M indicated in information output by the management unit 60 (step S2). The determination unit 70c determines whether or not an error has occurred in the movement of the physical object M based on a comparison result (step S3). In a case where it is determined that a difference between the current actual state of each of the robot 40 and the physical object M and the estimated state exceeds a predetermined threshold value, the determination unit 70c determines that an error has occurred in the movement of the physical object M. Moreover, in a case where it is determined that the difference does not exceed the predetermined threshold value, the determination unit 70c determines that no error has occurred in the movement of the physical object M.

In a case where it is determined that no error has occurred in the movement of the physical object M (NO in step S3), the determination unit 70c returns to the processing of step S1. Moreover, it is determined that in a case where an error has occurred in the movement of the physical object M (YES in step S3), the determination unit 70c outputs an error signal indicating that an error has occurred to the control unit 30 and outputs the control signal, the detection result, the image, and the current estimated states of the robot 40 and the physical object M to the replanning unit 80 together with the error signal.

In a case where the error signal is received, the identification unit 80a generates a new work target based on the control signal, the detection result, the image, and the current estimated states of the robot 40 and the physical object M received together with the error signal (step S4). The identification unit 80a outputs the generated new work target to the generation unit 20. The generation unit 20 generates a new sequence based on the new work target generated by the identification unit 80a to be described below (step S5) and outputs the generated sequence to the identification unit 80a. In a case where the identification unit 80a receives the sequence generated by the generation unit 20 for the new work target, the identification unit 80a outputs the received new sequence to the update unit 80b.

In a case where the new sequence is received from the identification unit 80a, the update unit 80b replaces states from a state at the movement source in the initial plan sequence received from the generation unit 20 to a state that is one of the plurality of states in the initial plan sequence at the movement destination of the physical object M in the new sequence with states from a state at the movement source to a state at the movement destination in the new sequence. That is, the update unit 80b moves the physical object M in the new sequence from a state of the physical object M after the error in a case where the error has occurred in the movement of the physical object M to a state that is one of the plurality of states in the initial plan sequence and then generates a post-error sequence for moving the physical object M by diverting the initial plan sequence from the one state to the state at the movement destination (step S6).

### (Advantages)

The robot system 1 according to the example embodiment of the present disclosure has been described above. In the control device 2 of the robot system 1, the generation unit 20 generates a state sequence including a plurality of states from the state at the movement source to the state at the movement destination of the physical object M. The determination unit 70c determines the occurrence of an error in the operation of the robot 40 based on a result of comparing the state of the generated state sequence with a state of the physical object M during the operation of the robot 40 operating according to the state sequence. In a case where it is determined that the error has occurred, the control unit 30 changes the state sequence so that a recovery operation for recovering from the error is performed.

Therefore, the control device 2 can reliably detect an operation error of the robot in operation.

As described above, the robot system 1 of the above-described example embodiment performs the recovery operation in a case where an error has occurred in the movement of the physical object M while one robot 40 grasps one physical object M and moves the physical object M from a movement source to a movement destination. However, the robot system 1 of another example embodiment of the present disclosure may include a plurality of robots 40 and recover from an error that has occurred in a case where the plurality of robots 40 move a plurality of physical objects M. For example, even if a plurality of robots 40 move a plurality of physical objects M via an intermediate point, because the movement from the movement source to the movement destination is determined with respect to each robot 40, it is only necessary to apply the above-described process in which one robot 40 grasps one physical object M and moves the physical object M from the movement source to the movement destination to the plurality of robots 40.

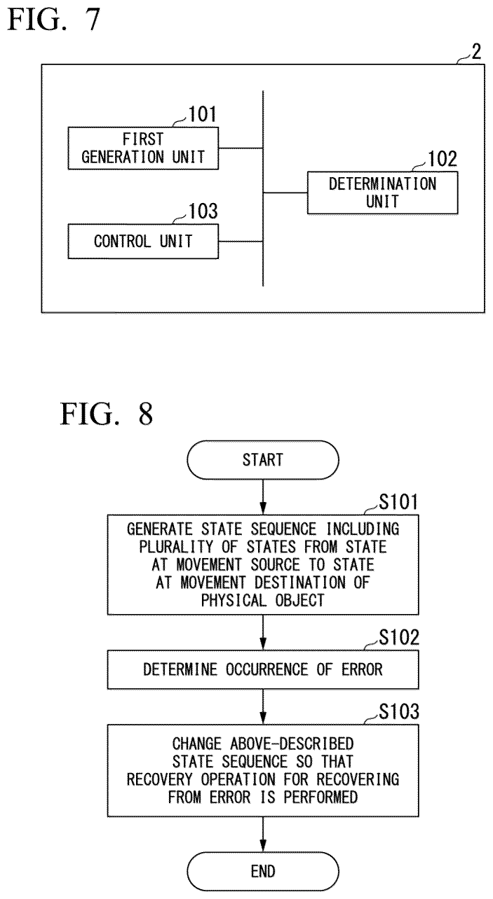

Next, a process of the control device 2 having a minimum configuration according to the example embodiment of the present disclosure will be described. FIG. 7 is a diagram showing an example of a processing flow of the control device 2 having the minimum configuration according to the example embodiment of the present disclosure. Here, the process of the control device 2 having the minimum configuration will be described with reference to FIG. 7. As shown in FIG. 7, the control device 2 includes a first generation unit 101 (an example of a first generation means), a determination unit 102 (an example of a determination means), and a control unit 105 (an example of a generation means). The first generation unit 101 generates a state sequence including a plurality of states from a state at a movement source to a state at a movement destination of a physical object. The first generation unit 101 can be implemented, for example, using functions of the generation unit 20 exemplified in FIG. 1. The determination unit 102 determines the occurrence of an error in the operation of the robot based on a result of comparing the state of the generated state sequence with a state of the physical object during the operation of the robot operating according to the state sequence. The determination unit 102 can be implemented, for example, using the functions of the determination unit 70c exemplified in FIG. 1. In a case where it is determined that the error has occurred, the control unit 105 changes the state sequence so that a recovery operation for recovering from the error is performed. The control unit 105 can be implemented, for example, using the functions of the control unit 30 exemplified in FIG. 1.

Next, the process of the control device 2 having the minimum configuration will be described. FIG. 8 is a diagram showing an example of a processing flow of the control device 2 having the minimum configuration. Here, the process of the control device 2 having the minimum configuration will be described with reference to FIG. 8.

The first generation unit 101 generates a state sequence including a plurality of states from a state at a movement source to a state at a movement destination of a physical object (step S101). The determination unit 102 determines the occurrence of an error in the operation of the robot based on a result of comparing the state of the generated state sequence with a state of the physical object during the operation of the robot operating according to the state sequence (step S102). In a case where it is determined that the error has occurred, the control unit 105 changes the state sequence so that a recovery operation for recovering from the error is performed (step S103).

The control device 2 having the minimum configuration according to the example embodiment of the present disclosure has been described above. The control device 2 can reliably detect an operation error of the robot in operation.

Also, in another example embodiment of the present disclosure, the reception unit 70a may receive at least one of a control signal output by the control unit 30 and a state of the robot 40 detected by the sensor 40a and the determination unit 70c may identify current actual states of the robot 40 and the physical object M based on information received by the reception unit 70a and the reception unit 70b.

Also, in the process in the example embodiment of the present disclosure, the order of processing steps may be changed in a range in which appropriate processing is performed.

Although example embodiments of the present disclosure have been described, the robot system 1, the control device 2, the input unit 10, the generation unit 20, the control unit 30, the robot 40, the imaging device 50, the management unit 60, the detection unit 70, the replanning unit 80, and other control devices described above may have a computer device inside. The process of the above-described processing steps is stored in a computer-readable recording medium in the form of a program, and the above process is performed in a case where the computer reads and executes the program. Specific examples of the computer are shown below.

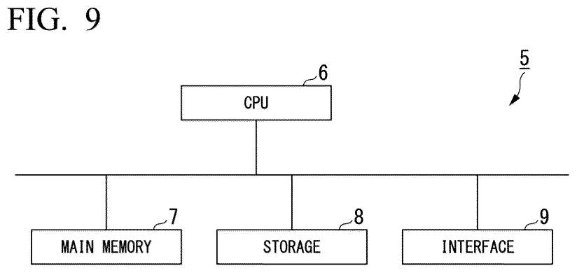

FIG. 9 is a schematic block diagram showing a configuration of the computer according to at least one example embodiment. As shown in FIG. 9, the computer 5 includes a CPU 6 (including a vector processor), a main memory 7, a storage 8, and an interface 9. For example, each of the robot system 1, the control device 2, the input unit 10, the generation unit 20, the control unit 30, the robot 40, the imaging device 50, the management unit 60, the detection unit 70, the replanning unit 80, and other control devices described above is implemented in the computer 5. An operation of each processing unit described above is stored in the storage 8 in the form of a program. The CPU 6 reads the program from the storage 8, loads the program into the main memory 7, and executes the above-described process according to the program. Moreover, the CPU 6 secures a storage area corresponding to each storage unit described above in the main memory 7 in accordance with the program.

Examples of the storage 8 include a hard disk drive (HDD), a solid-state drive (SSD), a magnetic disc, a magneto-optical disc, a compact disc read only memory (CD-ROM), a digital versatile disc read only memory (DVD-ROM), a semiconductor memory, and the like. The storage 8 may be internal media directly connected to a bus of the computer 5 or may be external media connected to the computer 5 via the interface 9 or a communication line. Moreover, in a case where this program is distributed to the computer 5 through a communication line, the computer 5 receiving the program may load the program into the main memory 7 and execute the above process. In at least one example embodiment, the storage 8 is a non-transient tangible storage medium.

Moreover, the above-described program may be a program for implementing some of the above-described functions. Also, the above-described program may be a so-called differential file (differential program) capable of implementing the above-described function in combination with a program already recorded on the computer device.

While some example embodiments of the present disclosure have been described, these are examples and are not to be considered as limiting the scope of the disclosure. Various additions, omissions, substitutions, and modifications can be made without departing from the spirit or scope of the disclosure.

### INDUSTRIAL APPLICABILITY

According to each aspect of the present disclosure, it is possible to reliably detect an operation error of a robot in operation.

### REFERENCE SIGNS LIST

1 Robot system
2 Control device
5 Computer
6 CPU
7 Main memory
8 Storage
9 Interface
10 Input unit
20 Generation unit
30 Control unit
40 Robot
50 Imaging device
60 Management unit
70 Detection unit
70a, 70b Reception unit
70c Determination unit
80 Replanning unit
80a Identification unit
80b Update unit

What is claimed is:

1. A control device comprising:
a memory configured to store instructions; and
a processor configured to execute the instructions to:
generate a state sequence including a plurality of states from a state at a movement source to a state at a movement destination of a physical object;
determine the occurrence of an error in an operation of a robot based on a result of comparing the state of the generated state sequence with a state of the physical object during the operation of the robot operating according to the state sequence; and
change the state sequence so that a recovery operation for recovering from the error is performed in a case where it is determined that the error has occurred.

2. The control device according to claim 1, comprising:
wherein the processor is configured to execute the instructions to:
generate a new state between a state of the physical object in which the error has occurred and one of the plurality of states from the movement source to the movement destination in a case where it is determined that the error has occurred;
generate a new state until the movement destination is reached from the state of the physical object in which the error has occurred based on the new state; and
generate a control signal based on the new state and control the robot so that the robot moves the physical object to the movement destination based on the generated control signal.

3. The control device according to claim 2, wherein the processor is configured to execute the instructions to identify a current actual state related to movement from the movement source to the movement destination based on at least one of the control signal and a state of the robot.

4. The control device according to claim 1, wherein the processor is configured to execute the instructions to:
estimate a current state related to movement of the physical object based on the state sequence; and
determine the occurrence of the error based on a result of comparing a current actual state related to movement from the movement source to the movement destination with a current state related to movement of the physical object.

5. The control device according to claim 3, wherein the processor is configured to execute the instructions to:
identify a current actual state related to movement from the movement source to the movement destination based on an image obtained by imaging the physical object.

6. A robot system comprising:
the control device according to claim 1; and
a robot configured to operate in accordance with control of the control device.

7. A control method comprising:
generating a state sequence including a plurality of states from a state at a movement source to a state at a movement destination of a physical object;
determining the occurrence of an error in an operation of a robot based on a result of comparing the state of the generated state sequence with a state of the physical object during the operation of the robot operating according to the state sequence; and
changing the state sequence so that a recovery operation for recovering from the error is performed in a case where it is determined that the error has occurred.

8. A non-transitory recording medium storing a program for causing a computer to:
generate a state sequence including a plurality of states from a state at a movement source to a state at a movement destination of a physical object;
determine the occurrence of an error in an operation of a robot based on a result of comparing the state of the generated state sequence with a state of the physical object during the operation of the robot operating according to the state sequence; and
change the state sequence so that a recovery operation for recovering from the error is performed in a case where it is determined that the error has occurred.
